(19) United States
(12) Patent Application Publication
(10) Pub. No.: US 2012/0202374 A1
(43) Pub. Date: Aug. 9, 2012

(54) PLUG CONNECTOR FOR PHOTOVOLTAIC CABLE SET

(76) Inventor: Michael STRACKE, Balve (DE)

(21) Appl. No.: 13/187,591

(22) Filed: Jul. 21, 2011

(30) Foreign Application Priority Data
Jul. 29, 2010 (DE) 102010032692.5

(51) Int. Cl. H01R 11/11

(52) U.S. Cl. 439/502

(57) ABSTRACT

A plug-type connector has a plug part fittable with a socket part parallel to a predetermined longitudinal axis, both of the parts having a body. One of the bodies is formed with a longitudinally projecting tongue formed at a spacing from the one body with a transversely projecting barb having an angled inner face turned toward the one body, forming an acute angle of 20° to 45° with a plane perpendicular to the longitudinal axis, and forming a wedge-shaped seat with a longitudinally extending side face of the tongue. The other of the bodies is formed extending inward from the other body with a longitudinally extending passage through which the barb can pass and is formed at an inner end of the passage with an angled inner face engageable with and generally parallel to the angled inner face of the barb on fitting of the bar through the passage.

### FIELD OF THE INVENTION

The present invention relates to a two-part plug connector. More particularly this invention concerns such a connector for a photovoltaic cable set.

### BACKGROUND OF THE INVENTION

A typical plug connector as described in US 2010/0311265, whose entire disclosure is herewith incorporated by reference, has a plug and a socket. The plug has a grip, a contact support, and a least one snap-in tongue extending in an insertion direction and carrying a snap-in barb pointing in a predetermined radial direction toward a plug outer face. The socket has a grip, a contact-support seat, and at least one snap-in hole generally complementary to the snap-in tongue of the plug, formed in the grip, and ending in a snap-in groove open outward toward an outer surface of the grip. Thus in a plugged-in condition of the plug and the socket the snap-in tongue extends through the snap-in hole and the snap-in barb engages behind the snap-in hole to lock the connected condition. Snap-in hole side walls of the socket extend out to the snap-in groove, laterally close the snap-in groove, and convert it into a snap-in recess open toward the outside at the plug outer face only in the predetermined radial direction.

The barb is formed at an longitudinal or axial spacing from an outer end face of the respective body with an angled inner face turned toward the respective body, forming an acute angle with a plane perpendicular to the longitudinal axis, and forming a wedge-shaped seat with a longitudinally extending side face of the tongue. The body is formed with a passage extending inward from an outer face and formed at an inner passage end with an angled inner face engageable with and generally parallel to the angled inner face of the bar when the tongue is engaged through the passage.

Plug connectors of such a type are widespread in the field of cabling of photovoltaic insulations in particular. They connect individual photovoltaic systems to one another and are used for connecting electrical lines with which the electricity generated is carried to transformers and transmission devices.

Since these lines must carry extremely high voltages, it is necessary to provide protection against unauthorized or unintended disconnection of the plug connectors. The above-described system offers one approach to solving this by laterally closing the catch grooves at the inner ends of the passages. This is an approach that has proven successful in practical use. Disconnection is possible only using a tool intended for this purpose.

However, it has been found that the catch elements of the plug connectors known from the prior art become detached from one another when they are subjected to forces directed radially to the longitudinal axis. These radial forces correspond approximately to a bending load of a plug connector in the area of the contact surfaces of the two contact holders whereby compression of the one catch connection and overextension of the opposing catch connection occurs in particular. The overstretched catch connection here becomes loosened and then in the case of an opposite bending load, the initially compressed catch connection becomes detached. Subsequently, the contact holders can be disconnected from one another even without an auxiliary tool because the catch connection no longer exists.

### OBJECTS OF THE INVENTION

It is therefore an object of the present invention to provide an improved plug connector for a photovoltaic cable set.

Another object is the provision of such an improved plug connector for a photovoltaic cable set that overcomes the above-given disadvantages, in particular whose contact holders cannot be manipulated so that they can be released from one another without an auxiliary tool, not even by bending.

### SUMMARY OF THE INVENTION

A plug-type connector for a photovoltaic cable set and has according to the invention a plug part fittable with a socket part parallel to a predetermined longitudinal axis, both of the parts having a body. One of the bodies according to the invention is formed with a longitudinally projecting tongue formed at a longitudinal spacing from an outer end face of the one body with a transversely projecting barb having an angled inner face turned toward the one body, forming an acute angle of 20° to 45° with a plane perpendicular to the longitudinal axis, and forming a wedge-shaped seat with a longitudinally extending side face of the tongue. The other of the bodies is formed extending inward from an outer end face of the other body with a longitudinally extending passage through which the barb can pass and is formed at an inner end of the passage with an angled inner face engageable with and generally parallel to the angled inner face of the barb on fitting of the bar through the passage. When the bodies are fitted together their outer end faces abut and the tongue of the one body or contact holder extends all the way through the passage of the other body or contact holder.

An embodiment in which the barb catch face forms an angle α of approximately 25° with the plane is especially preferred.

In addition, it has proven to be advantageous if the passage catch face forms an angle β of 5° to 50° with the plane, in particular if the passage catch face forms an angle β of approximately 15° or 45° with the plane.

The essential advantage of the invention may be seen in the fact that only the geometry of the catch faces of the contact holders has been altered to achieve the object according to the invention. It has surprisingly been found that a change in the geometries as proposed here is completely sufficient to ensure reliable engagement of the two contact holders even under a bending load. This is of crucial importance in particular inasmuch as the plug connectors known from the prior art, in particular as described above, are widely used in photovoltaic cabling. Since only the geometries of the catch faces have been altered, full plug compatibility with plug connectors from the prior art is retained.

Furthermore, an embodiment in which the length of the tongue carrying the catch barb between the base or end face of the first contact holder and the intersection of the face extending at the angle α formed by the barb catch face with the plane between the end face of the first contact holder and the vertex of the angle α amounts to approximately 1.19 times to 1.29 times the distance between the end face of the second contact holder and the intersection of the face extending at the angle β formed by the passage catch face with the plane.

It is especially preferred if the tongue length of the catch barb between the end face of the first contact holder and the intersection of the plane of the face extending at the angle α formed by the barb catch face with the plane amounts to approximately 1.24 times the distance between the end face of the second contact holder and the vertex of the face extending at the angle β formed by the passage catch face with the plane.

To this extent, it has also been recognized that minor changes in the tongue length of the catch barb which do not negatively impair the plug compatibility with previous plug connectors have a positive influence on the technical effect of the changes in geometry of the catch faces.

### BRIEF DESCRIPTION OF THE DRAWING

The above and other objects, features, and advantages will become more readily apparent from the following description, reference being made to the accompanying drawing in which:

FIG. 1 is a perspective view of a connector according to the invention in fitted-together or assembled condition;

FIG. 2 is a perspective view of the connector with its parts or holders separated but aligned;

FIG. 3 is a large-scale view of a detail of the tongue part of the connector; and

FIG. 4 is a large-scale view of a detail of the complementary catch passage of the connector.

### SPECIFIC DESCRIPTION

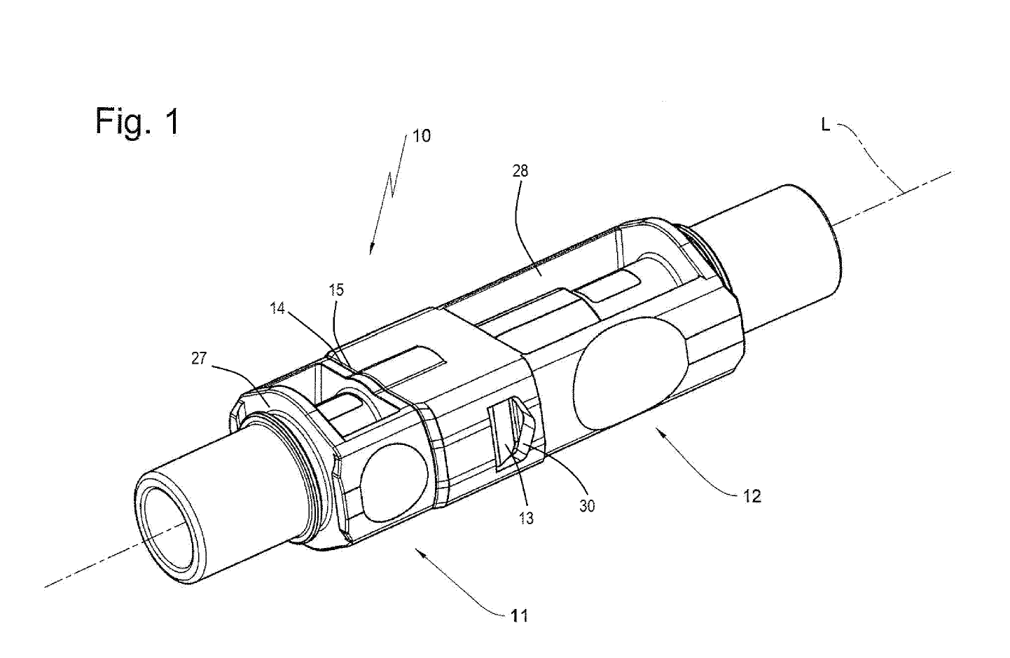

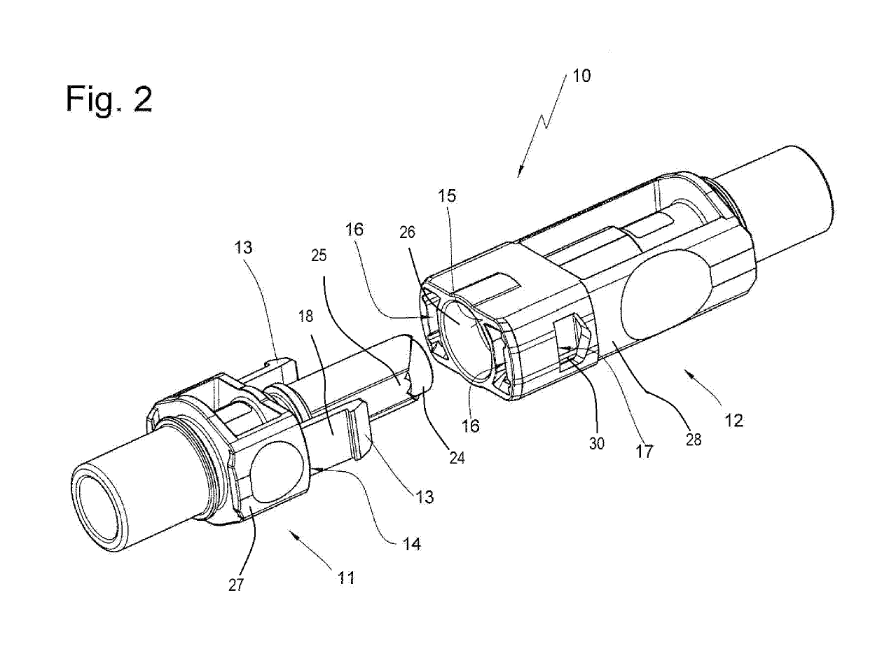

As seen in FIGS. 1 and 2, a plug connector 10 comprises a first contact holder or part 11 having a body 27 with an outer end face 14 and a second contact holder or part 12 having a body 28 with an end face 15. Both the connector parts 11 and 12 are made of plastic and are centered on an axis, and the axes are coaxial at L when they are fitted together as shown in FIG. 1. The part 11 is a plug and has a projection 24 carrying a pair of diametrally opposite and longitudinally extending contacts 25. The part 12 is a socket formed with a complementary passage 26 holding two more complementary but unillustrated contacts.

The plug part or holder 11 carries two axially is outwardly projecting tongues 18 having at their outer ends barbs 13, these tongues 18 being radially elastically deflectable and diametrally flanking the center projection 24. The plug part 12 is formed with a pair of tunnels or passages 16 into which the tongues 18 with their barbs 13 can fit, and inner ends of these passages 16 are radially exposed and open diametrally oppositely through respective windows 30 as described in the above-cited patent publication. Outer edges of these windows 30 form catch faces 17 against which the barbs 13 can engage to lock the two parts 11 and 12 together. The barbs 13 are each only exposed radially in one direction at the windows 30 so that only insertion of a tool into both of the windows 30 simultaneously will free the parts 11 and 12 from each other.

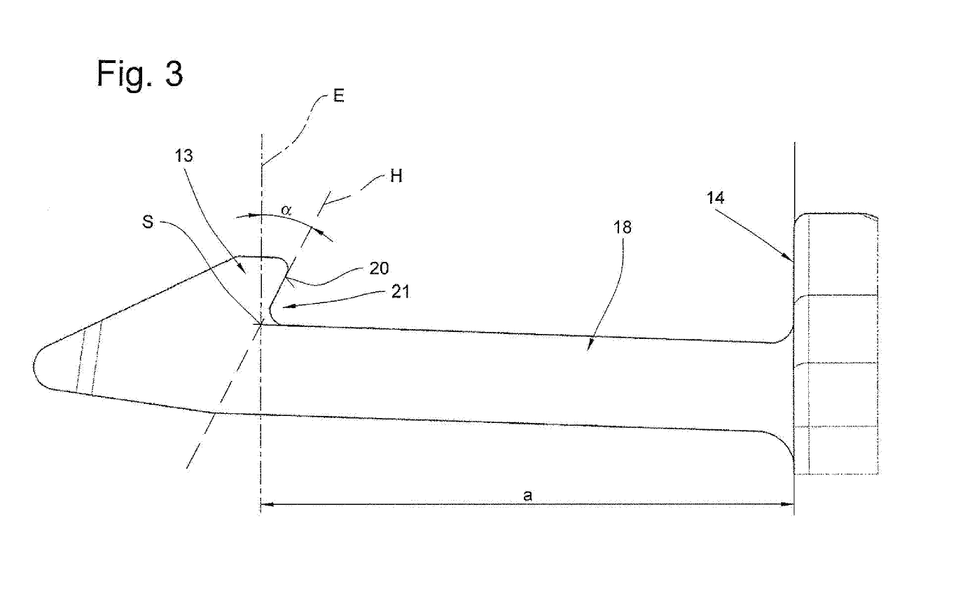

As shown in FIG. 3, the catch barb 13 projects radially outward from the outer end of the elastically bendable tongue 18 extending longitudinally from the end face 14 of the first contact holder 11. A substantially planar face 20 of the barb 13 is directed axially generally toward the end face 14. A wedge-shaped clearance between the tongue 18 and the barb 13 is the so-called barb seat 21. A plane E aligned perpendicular to the longitudinal axis L of the plug connector 10 (see FIG. 1) is shown as a dot-dash line in FIG. 3. A plane H of the face 20 crosses the plane E. Their intersection S forms the vertex of an acute angle α. A length a of the tongue 18 is determined by the distance between the vertex S of the angle α and the end face 14.

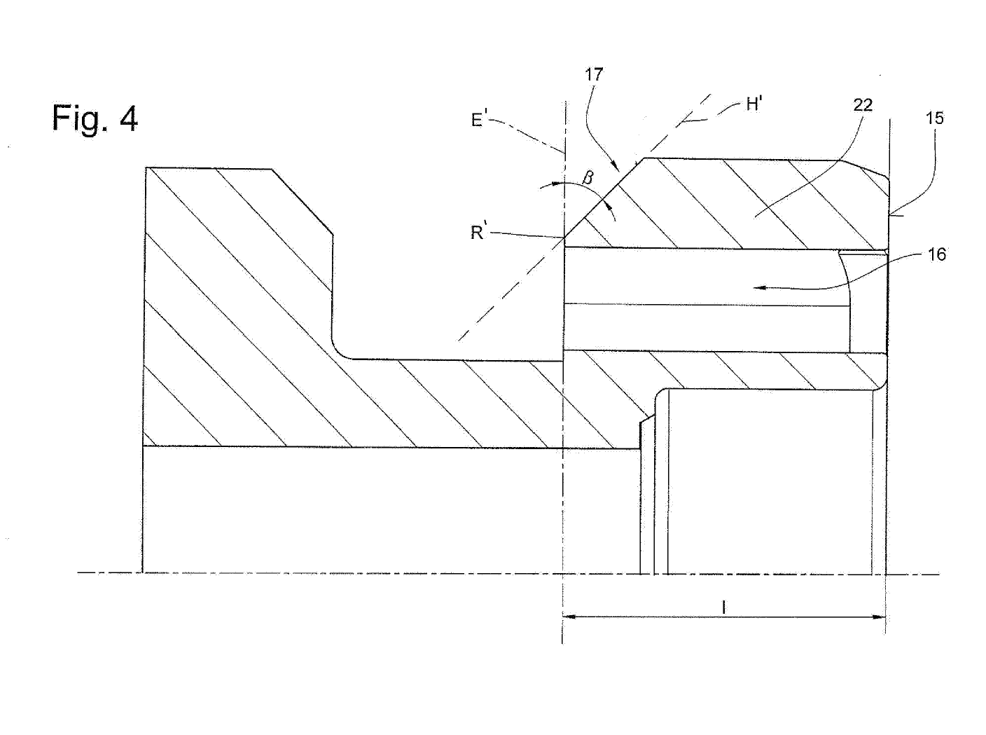

FIG. 4 is a longitudinal section through the contact holder 12, not to the same scale as FIG. 3. The catch face 17 is spaced longitudinally from the end face 15 by a wall 22 forming the passage 16. Here again, a plane E′ perpendicular to the longitudinal axis L of the plug connector 12 is shown with a dot-dash line. A plane H′ of the catch face 23 is shown with a dashed line. The planes E′ and H′ form legs of an acute angle β. Their intersection R′ is the vertex of the angle β. A length l of the passage is defined by the distance between the end face 15 and the vertex R and is labeled l.

According to the invention, the barb catch face 20 forms an angle α of at least 20° to at most 45° with the plane E. The passage catch face 17 forms the angle β of at least 5° to at most 50° with the plane E. An angle α of 25° and an angle β of 15° or 45° are preferred. The ratio of the angle α to the angle β may be between 4 and 0.4, but a ratio of angle α to angle β of 0.6 is preferred. It is has also proven to be advantageous if the length a of the tongue 18 is 1.19 times to 1.29 times, in particular 1.24 times the length of the passage.

In particular due to the angled positions of the barb catch face 20 and the passage catch face 23 as indicated above, the catch connection can absorb the bending forces mentioned above without separating. The change in the length of the tongue 18 additionally improves the secure holding of the catch connection.

It has also been found that the geometries of the passage catch face and the barb catch face as described above offer another important advantage. Basically the plug connector 10 is to be designed according to the valid standards so that disconnection without a tool is impossible. If anyone attempts a forcible disconnection of the inventive plug connector by the bending mentioned above, the catch elements of the contact holder will become twisted and entangled with one another. Consequently, plug connectors that have withstood a forcible disconnection attempt can no longer be disconnected using the intended tools. Disconnection can then be accomplished only by destroying the plug connectors.

Consequently, any attempts at a forcible disconnection would become obvious in a plant inspection. The person performing the inspection would be warned in checking such plug connectors and would not be surprised by any consequential damage to the plug connector.

I claim:

1. A plug-type connector for a photovoltaic cable set and comprising a plug part fittable with a socket part parallel to a predetermined longitudinal axis, both of the parts having a body, the improvement wherein
one of the bodies is formed with a longitudinally projecting tongue formed at a longitudinal spacing from an outer end face of the one body with a transversely projecting barb having an angled inner face turned toward the one body, forming an acute angle of 20° to 45° with a plane perpendicular to the longitudinal axis, and forming a wedge-shaped seat with a longitudinally extending side face of the tongue; and
the other of the bodies is formed extending inward from an outer end face of the other body with a longitudinally extending passage through which the barb can pass and is formed at an inner end of the passage with an angled inner face engageable with and generally parallel to the angled inner face of the barb on fitting of the bar through the passage.

2. The connector defined in claim 1 wherein the angled inner face of the barb extends at about 25° to the plane.

3. The connector defined in claim 1 wherein the angled inner face on the inner end of the passage extends at an acute angle of 5° to 50° ° to the plane.

4. The connector defined in claim 1 wherein the acute angle of the angled inner face on the inner end of the passage is 15° to 45°.

5. The connector defined in claim 1 wherein a length of the tongue measured between the outer end face of the one body and an intersection of the plane with a plane of the inner face of the barb equal to between 1.19 and 1.29 times a distance between the outer end face of the other body and an intersection of a plane of the angled face and a plane perpendicular to the axis and at an innermost edge of the angled face.

6. The connector defined in claim 1 wherein a length of the tongue measured between the outer end face of the one body and an intersection of the plane with a plane of the inner face of the barb equal to about 1.24 times a distance between the outer end face of the other body and an intersection of a plane of the angled face and a plane perpendicular to the axis and at an innermost edge of the angled face.

7. The connector defined in claim 1 wherein each of the bodies carries a contact and the contacts engage each other when the bodies are fitted longitudinally together with the tongue through the passage.

8. The connector defined in claim 7 wherein one of the bodies has an axial projection carrying the respective contact and the other of the bodies has an axially extending socket recess into which the projection fits with the contacts in engagement on fitting of the tongue through the passage.

9. The connector defined in claim 1 wherein both the angled faces extend at a small acute angle to each other when the tongue is fitted through the passage.

10. The connector defined in claim 10 wherein the small acute angle opens transversely outward away from the bodies.

11. The connector defined in claim 1 wherein the one body has two of the tongues spaced transversely from each other and the other body has two of the passages similarly transversely spaced relative to each other.

12. The connector defined in claim 11 wherein the one body has between the respective two tongues an axial projection carrying a pair of contacts and the other body has between the two respective passages an axially open socket recess into which the projection can fit and that holds a pair of contacts engageable with the contacts of the projection.
